(19) United States
(12) Patent Application Publication
(10) Pub. No.: US 2012/0260177 A1
(43) Pub. Date: Oct. 11, 2012

(54) GESTURE-ACTIVATED INPUT USING AUDIO RECOGNITION

(75) Inventor: Trevor Sehrer, San Jose, CA (US)

(73) Assignee: Google Inc., Mountain View, CA (US)

(21) Appl. No.: 13/251,054

(22) Filed: Sep. 30, 2011

Related U.S. Application Data
(63) Continuation of application No. 13/083,322, filed on Apr. 8, 2011.

(51) Int. Cl. G06F 3/16; G10L 21/00; G06F 3/048

(52) U.S. Cl. 715/727; 704/275; 704/E21.001

(57) ABSTRACT

In one example, a method includes, displaying, at a presence-sensitive screen of a computing device, an input field in a region of a graphical user interface (GUI). The method further includes receiving, at the presence-sensitive screen, user input including one or more gestures to select the input field, wherein the one or more gestures to select the input field include motion at a location of the presence-sensitive screen that corresponds to the region of the GUI displaying the input field. The method also includes, while the input field is selected, detecting, by the computing device, an audio signal and identifying, by the computing device, at least one input value based on the detected audio signal. The method also includes assigning, by the computing device, the at least one input value to the input field in the GUI.

This application is a continuation of U.S. application Ser. No. 13/083,322, filed Apr. 8, 2011 the entire contents of which are incorporated herein by reference.

### TECHNICAL FIELD

This disclosure relates to electronic devices and, more specifically, to graphical user interfaces of electronic devices.

### BACKGROUND

A user may interact with applications executing on a mobile computing device (e.g., mobile phone, tablet computer, smart phone, or the like). For instance, a user may install, view, or delete an application on a computing device.

In some instances, a user may interact with the mobile device through a graphical user interface. For instance, a user may interact with a graphical user interface using a presence-sensitive display (e.g., touchscreen) of the mobile device.

### SUMMARY

In one example, a method includes, displaying, at a presence-sensitive screen of a computing device, an input field in a region of a graphical user interface. The method further includes receiving, at the presence-sensitive screen of the computing device, user input including one or more gestures to select the input field, wherein the one or more gestures to select the input field include motion at a location of the presence-sensitive screen that corresponds to the region of the graphical user interface displaying the input field. The method also includes while the input field is selected, detecting, by the computing device, an audio signal. The method further includes identifying, by the computing device, at least one input value based on the detected audio signal; and assigning, by the computing device, the at least one input value to the input field in the graphical user interface.

In one example, a computer-readable storage medium encoded with instructions that, when executed, cause one or more processors of a computing device to perform operations including: displaying, at a presence-sensitive screen, an input field in a region of a graphical user interface. The instructions, when executed, further cause one or more processors to perform an operation including receiving, at the presence-sensitive screen, user input including one or more gestures to select the input field, wherein the one or more gestures to select the input field include motion at a location of the presence-sensitive screen that corresponds to the region of the graphical user interface displaying the input field. The instructions, when executed, also cause one or more processors to perform an operation including, while the input field is selected, detecting an audio signal. The instructions, when executed, further cause one or more processors to perform an operation including identifying at least one input value based on the detected audio signal; and assigning the at least one input value to the input field in the graphical user interface.

In one example, a computing device, including: one or more processors. The computing device also includes an output device to display an input field in a region of a graphical user interface. The device further includes a first input device to receive user input including one or more gestures to select the input field, wherein the one or more gestures to select the input field include motion at a location of the output device that corresponds to the region of the graphical user interface displaying the input field. The device also includes a second input device to detect an audio signal. The device further includes an audio conversion module operable by the one or more processors to identify at least one input value based on the detected audio. The device also includes means for assigning the at least one input value to the input field in the graphical user interface.

The details of one or more examples of this disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example of a computing device that may be configured to execute one or more applications, in accordance with one or more aspects of the present disclosure.

FIG. 2 is a block diagram illustrating further details of one example of the computing device shown in FIG. 1, in accordance with one or more aspects of the present disclosure.

FIG. 3 is a flow diagram illustrating an example method that may be performed by a computing device to enable a user to efficiently input data into one or more input fields of an application.

FIG. 4 is a block diagram illustrating an example of a computing device that displays an input field using a projector, in accordance with one or more aspects of the present disclosure.

FIGS. 5-7 are block diagrams illustrating example techniques that enable a user to efficiently input data into one or more input fields of an application, in accordance with one or more aspects of the present disclosure.

### DETAILED DESCRIPTION

In general, aspects of the present disclosure are directed to techniques that enable a user to efficiently input data into one or more input fields of an application. A common example of an input field in a graphical user interface is a text box. Conventionally, to enter an input value into a text box, a user must type each character of the input value using a keyboard or similar device. In some examples, entering a large number of input values into a smartphone or other computing device may be cumbersome and/or require substantial amounts of time.

In one aspect of the present disclosure, a computing device may include an input device such as a microphone. The computing device also includes an output device, e.g., a presence-sensitive screen, to receive gestures as input and display output. An application executing on the computing device may display one or more input fields that may each be assigned one or more input values based on provided user input. The application may further detect a gesture at a location of the presence-sensitive screen that displays an input field.

For example, in one use scenario, the application may detect when a user performs a gesture using his/her finger at the location of the input field. In one example, a user may select an input field by performing a touch gesture (e.g., long-press touch gesture) at the location of the presence-sensitive screen that displays an input field. While selecting the input field, the user may speak an input value that is received by the computing device via an audio signal. When the user releases his/her finger from the presence-sensitive screen, the input field may no longer selected. In response to determining the input field is no longer selected, the application may execute an operation (e.g., speech-to-text operation) that identifies an input value based on the audio signal. In one example, the input value may include text that may subsequently be assigned to the input field. In this way, a user may quickly and accurately provide input values for input fields.

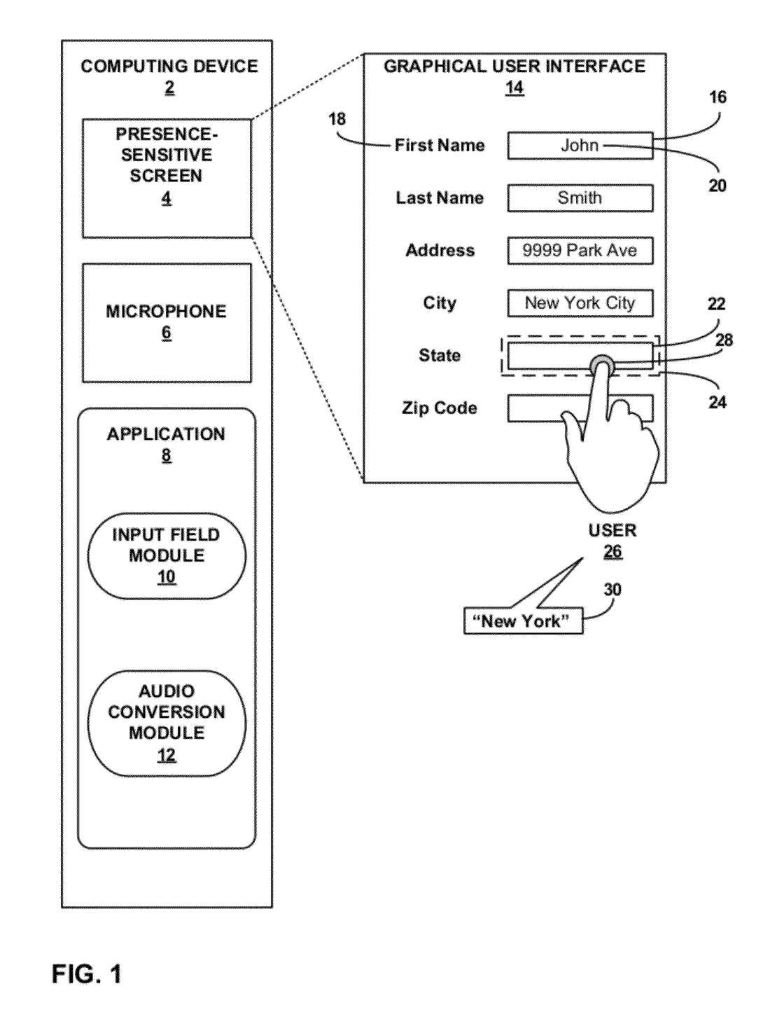

FIG. 1 is a block diagram illustrating an example of a computing device 2 that may be configured to execute one or more applications, e.g., application 8, in accordance with one or more aspects of the present disclosure. As shown in FIG. 1, computing device 2 may include a presence-sensitive screen 4, a microphone 6, and an application 8. Application 8 may, in some examples, include an input field module 10 and an audio conversion module 12.

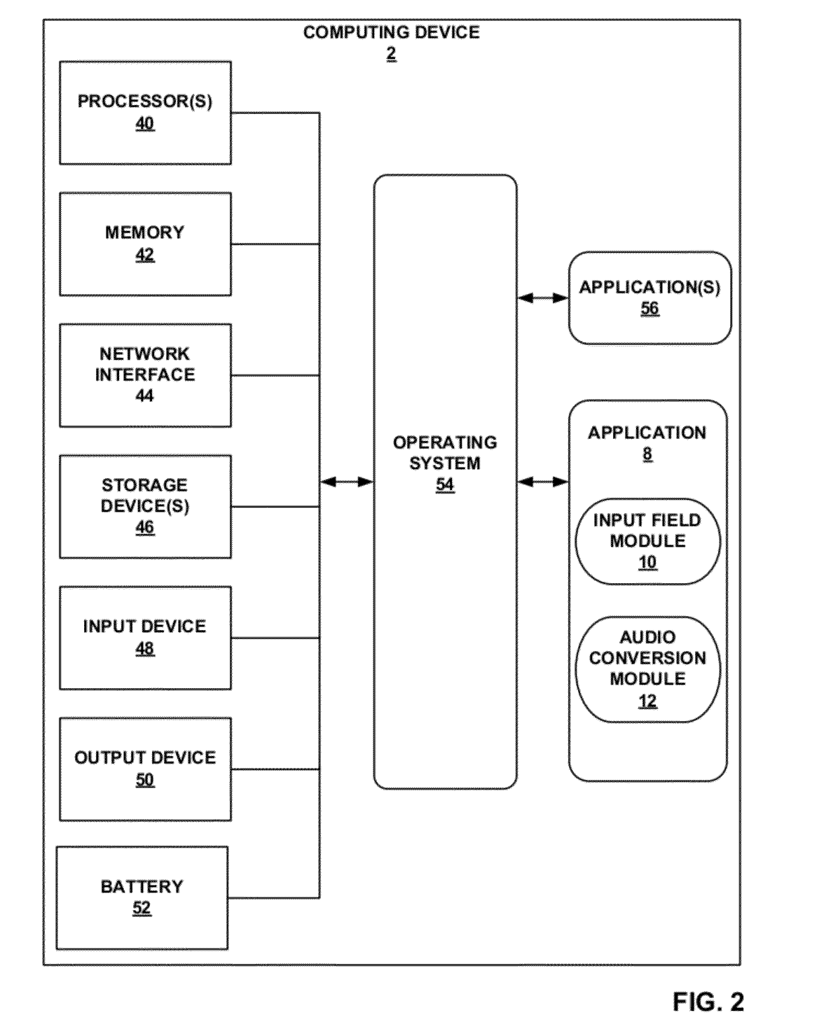

Computing device 2, in some examples, includes or is a part of a portable computing device (e.g. mobile phone/netbook/laptop/tablet device) or a desktop computer. Computing device 2 may also connect to a wired or wireless network using a network interface (see, e.g., FIG. 2). One non-limiting example of computing device 2 is further described in the example of FIG. 2.

Computing device 2, in some examples, includes one or more input devices. In some examples, an input device may be a presence-sensitive screen 4. Presence-sensitive screen 4, in one example, generates one or more signals corresponding to a location selected by a gesture performed on or near the presence-sensitive screen 4. In some examples, presence-sensitive screen 4 detects a presence of a input unit, e.g., a finger that is in close proximity to, but does not physically touch, presence-sensitive screen 4. In other examples, the gesture may be a physical touch of presence-sensitive screen 4 to select the corresponding location, e.g., in the case of a touch-sensitive screen. Presence-sensitive screen 4, in some examples, generates a signal corresponding to the location of the input unit. Signals generated by the selection of the corresponding location are then provided as data to applications and other components of computing device 2.

In some examples, computing device 2 may include an input device such as a joystick, camera or other device capable of recognizing a gesture of user 26. In one example, a camera capable of transmitting user input information to computing device 2 may visually identify a gesture performed by user 26. Upon visually identifying the gesture of the user, a corresponding user input may be received by computing device 2 from the camera. The aforementioned examples of input devices are provided for illustration purposes and other similar example techniques may also be suitable to detect a gesture and detected properties of a gesture.

In some examples, computing device 2 includes a microphone 6. Microphone 6 may, in some examples, include an acoustic-to-electric transducer or sensor that converts sound waves into one or more electrical signals. In some examples, microphone 6 may convert an electrical signal corresponding to a sound wave into a digital representation that may be used by computing device 2 in various operations. In some examples, microphone 6 may transmit data to various applications, e.g., application 8, and components of computing device 2.

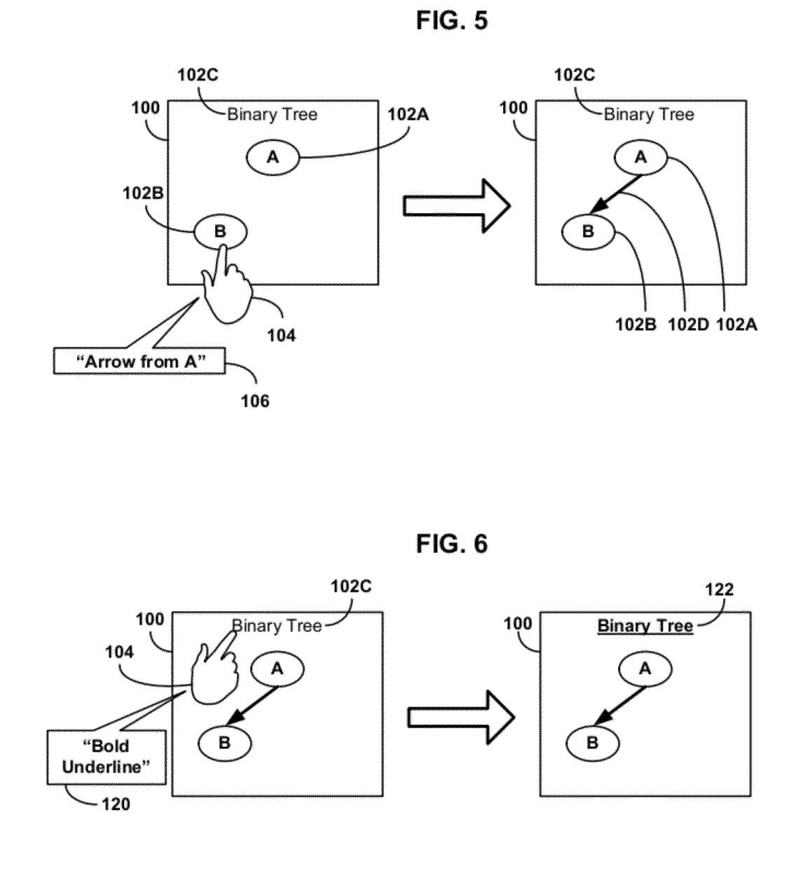

In some examples, computing device 2 includes an output device, e.g., presence-sensitive screen 4. In some examples, presence-sensitive screen 4 may be programmed by computing device 2 to display graphical content. Graphical content, generally, includes any visual depiction displayed by presence-sensitive screen 4. Examples of graphical content may include images, text, videos, visual objects (see e.g., FIG. 5) and/or visual program components such as scroll bars, text boxes, buttons, etc. In one example, application 8 may cause presence-sensitive screen 4 to display graphical user interface (GUI) 14.

As shown in FIG. 1, application 8 may execute on computing device 2. Application 8 may include program instructions and/or data that are executable by computing device 2. Examples of application 8 may include a web browser, email application, text messaging application or any other application that receives user input and/or displays graphical content.

In some examples, application 8 causes GUI 14 to be displayed in presence-sensitive screen 4. GUI 14 may include interactive and/or non-interactive graphical content that presents information of computing device 2 in human-readable form. In some examples GUI 14 enables user 16 to interact with application 8 through presence-sensitive screen 4. For example, user 26 may perform a gesture at a location of presence-sensitive screen 4 that displays input field 16 of GUI 14. In response to receiving the gesture, an operation associated with input field 16 may be executed by computing device 2. In this way, GUI 14 enables user 26 to create, modify, and/or delete data of computing device 2.

In some examples, GUI 14 of application 8 may include one or more input fields. Examples of input fields, as shown in FIG. 1, include input field 16 and input field 22. An input field may include any element of GUI 14 that may receive information from a user. Some examples of input fields include text box controls and free form drawing controls. Input fields enable a user to enter input values into a computing device. In some examples, an input value may include any information the user enters into an input field. For example, as shown in FIG. 1, input fields 16, 22 may be text box controls. User 26 may provide input values for input fields 16, 22 that may be received by application 8 for further processing.

In some examples, an input field may be identified by a label. For example, label 18 may identify input field 16. In this way, user 26 may enter an input value into an appropriate input field based on its corresponding label. For example, application 8 may request that user 26 enter a First Name into input field 16. Label 18 may further be associated with input field 16 by, e.g., its arrangement in proximity to input field 16. Because label 18 indicates that input field 16 requires a First Name, user 26 may provide “John” as input value 20. In some examples, an input value assigned to an input field may be displayed in the input field itself For example, as shown in FIG. 1, input value 20 includes the text “John” and is assigned to input field 16. Input value 20 is displayed in input field 16, in the current example, because input value 20 is assigned to input field 16.

Input fields may be located in any of various regions of GUI 14. For example, as shown in FIG. 1, input field 22 is located in region 24. A region may, in some examples, be a defined area within GUI 14. GUI 14 may, in some examples, include many different regions that may each be uniquely identifiable. In some examples, application 8 may perform one or more operations associated with input field 22 when user 26 selects a location of presence-sensitive screen 4 that corresponds to region 24. In this way, one or more operations may be associated with an input field that is included in a region. For example, user 26 may provide a user input that includes performing a single-tap gesture to select input field 22 in order to initiate an operation associated with input field 22. The single-tap gesture of user 26 may include a motion of a finger of user 26 at location 28 corresponding to region 24. In response to the gesture at location 28, application 8 may execute an operation corresponding to input field 22 because input field 22 is included in region 24. A user input, generally, may include any one or more gestures provided by a user to interact with computing device 2 via presence-sensitive screen 4. In some examples, user input may include a long-press, swipe, pinch-open, pinch-close, single-tap, double-tap, or other gesture.

In some examples, a user input provided by user 26 to select input field 22 may cause input field module 10 to execute one or more operations. Input field module 10 may perform various operations associated with input fields such as input fields 16, 22. For example, input field module 10 may assign input values to input fields. In other examples, input field module 10 may cause an input value assigned to an input field to be displayed in the input field. In other examples, a user input that selects input field 16 may cause input field module 10 to execute audio conversion module 12. For example, user 26 may perform a long-press gesture at location 28 of region 24, which causes input field module 10 to execute audio conversion module 12.

In some examples, audio conversion module 12 may identify one or more input values based on an audio signal. In some examples, an input value may include text, symbols, or other indicia. Thus, in one example, audio conversion module 12 may initially receive digital audio data from microphone 6. For example, user 26 may speak the phrase “New York,” which is received as an audio signal by microphone 6. Microphone 6 may convert the audio signal to digital audio data, which is received by audio conversion module 12. The digital audio data may include a digital representation of the audio signal. Audio conversion module 12, may identify one or more input values based on the digital audio data received from microphone 6 into text. Thus, using the aforementioned techniques, audio conversion module 12 may identify the input value “New York” based on the audio signal received by microphone 6. In this way, audio conversion module 12 may consequently generate the text “New York.” In some examples, audio conversion module 12 may send the text “New York” to input field module 10, which may assign the text to an input field. Numerous techniques to identify input values, e.g., visual representations and/or operations, based on an audio signal are well-known in the art and may be implemented by audio conversion module 12.

One example technique is described hereinafter to identify input values, e.g., visual representations and/or operations, based on an audio signal audio data. In the current example, microphone 6 of computing device 2 may initially receive an audio signal such as a sound wave. A sound wave may initially be received as an analog wave. An analog-to-digital converter implemented as hardware and/or software within microphone 6 and/or computing device 2 may convert the analog wave into digital audio data that includes a digital representation of the audio signal. Audio conversion module 12 may subsequently receive the digital audio data. Upon receiving the digital audio data, audio conversion module 12 may divide the digital audio data into one or more digital audio segments. A digital audio segment may include a subset of the digital audio data. Audio conversion module 12 may, in some examples, select one or more of the digital audio segments for further processing.

In some examples, audio conversion module 12 may activate a grammar. A grammar includes one or more symbols that are associated with one or more pre-defined digital audio segments. In one example, a symbol may be an input value. Each symbol may include, for example, a character in the alphabet. In other examples, a symbol may include a phoneme, word, or phrase of a language. In other examples, the one or more symbols may include images, videos or other visual objects. In still other examples, a symbol may correspond to an operation to be executed by computing device 2. In any case, audio conversion module 12 may compare, for example, a selected digital audio segment with one or more pre-defined digital audio segments.

Audio conversion module 12 may, in one example, select the symbol associated with the pre-defined digital audio segment that matches the selected audio segment. In some examples, a match may indicate a degree of similarity, within a similarity interval, between the selected digital audio data segments and the plurality of pre-defined digital audio data segments. For example, a degree of similarity may include a ratio of equivalence between the selected digital audio data segments and a pre-defined digital audio segment of the plurality of pre-defined digital audio data segments. Numerous statistical modeling techniques to identify matches between digital audio data are well-known in the art.

In one example technique of the present disclosure, a user may enter an input value into an input field by selecting the desired input field and speaking the input value while the input field is selected. For example, as shown in FIG. 1, user 26 may wish to enter an input value into input field 22. User 26 may initially provide a gesture that includes a long-press gesture at location 28 to select input field 22. Because input field 22 is included within region 24 and the long-press gesture is performed at location 28, input field 22 may be selected. In some examples, input field module 10 may change the appearance of input field 22 when selected. For example, input field module 10 may highlight input field 22 with color shading or may cause the edges of input field 22 to change in appearance, e.g., bolding or coloring.

In some examples, input field module 10 may detect when input field 22 is initially selected and when input field 22 is subsequently deselected. In this way, input field module 10 may execute one or more operations in response to selections of input field 22. For example, user 26 may initially select input field 22 by performing a long-press at location 28. User 26 may perform the long-press by holding his/her finger at or near presence-sensitive screen 4 at location 28. While the finger is at or near presence-sensitive screen 4, input field module 10 may determine input field 22 is selected and may perform one or more operations. In some examples, when user 26 removes his/her finger from presence-sensitive screen 4, such that the finger is no longer detectable by presence-sensitive screen 4, input field module 10 may determine that input field 22 is longer selected and may perform one or more operations.

In some examples, when user 26 initially selects input field 22, input field module 10 may execute audio conversion module 12. Once executing, audio conversion module 12 may receive digital audio data from microphone 6. In the current example, user 26 may speak the phrase “New York” 30, which may be received by microphone 6. Audio conversion module 12 may receive digital audio data from microphone 6 that corresponds to the phrase “New York.” User 26 may subsequently remove his/her finger from presence-sensitive screen 4 such that input field module 10 determines input field 22 is no longer selected. Input field module 10, may send notification data to audio conversion module 12 indicating that input field 22 is no longer selected. Audio conversion module 12, in response to receiving the notification data from input field module 10, may convert the digital audio data received by microphone 6 corresponding to the phrase “New York” to text. Input field module 10 may, in some examples, assign the text to input field 22 automatically or manually in response to a user input from user 26. Input field module 10 may include means for assigning the at least one input value to the input field in the graphical user interface. For example, input field module 10 may store text, e.g., “New York” in temporary or permanent storage of computing device 2. Input field module 10 may subsequently select an identifier, e.g., a pointer or reference, which identifies input field 22. Input field module 10 may then associate with and/or assign the text to the pointer or reference that identifies input field 22. In this way the text may be assigned field.

In one example use case, user 26 may wish to enter the input value “New York” into input field 22 by speaking the phrase “New York.” In the example use case, application 8 may be a web browser application. Consequently, presence-sensitive screen 4 may display an e-commerce web page that has been retrieved by application 8. The web page may require a purchaser to enter shipping address information and may include multiple input fields, e.g., input fields 16, 22, to receive the required information.

In the current example use case, to enter the input value “New York” into input field 22, user 26 may initially select input field 22 using techniques previously described herein. For example, user 26 may perform a long-press gesture on presence-sensitive screen 4 at location 28 of region 24. To perform the long press-gesture user 26 may hold his/her finger at location 28 on presence-sensitive screen 4. In response to selecting input field 22, input field module 10 may execute audio conversion module 12. While input field 22 is selected, user 26 may speak the phrase “New York” 30, which is received by microphone 6. Audio conversion module 12 may receive digital audio data that represents the audio signal from microphone 6. User 26 may subsequently terminate the long-press gesture by removing his/her finger from presence-sensitive screen 4 such that the finger may no longer be detected by presence-sensitive screen 4. In response to terminating the long-press gesture, input field module 10 may send notification data to audio conversion module 12 that indicates input field 22 is no longer selected. Audio conversion module 12 may subsequently convert the digital audio data received from microphone 6 to the text “New York.” In this way, audio conversion module 12 may identify the input value “New York” based on the detected audio signal. The text “New York” may be received by input field module 10, which may assign the text “New York” to input field 22. In some examples, input field module 10 may cause presence-sensitive screen 4 to display the text “New York” in input field 22 when “New York” is assigned to input field 22. In some examples, input field module 10 may assign the at least one input value, e.g., “New York,” to input field 22 while the input field is selected.

In other examples, to select input field 22, user 26 may single tap input field 22 by holding his/her finger at or near presence-sensitive 4 for approximately 0.25-1 seconds. In response to selecting input field 22, input field module 10 may execute audio conversion module 12. While input field 22 is selected, user 26 may speak the phrase “New York” 30, which is received by microphone 6. After a duration of silence, audio conversion module 12 and/or microphone 6 may stop receiving audio signals. Consequently audio module 12 may convert the digital audio data received from microphone 6 to text. In some examples, audio conversion module 12 and/or microphone 6 may stop receiving audio signals when user 26 single taps input field 22 after initially selecting input field 22. In some examples, computing device 2 may determine that input field 22 is selected by first determining an input unit, e.g., user 26's finger, is positioned at or near presence-sensitive screen 4 such that the input unit is detectable by presence-sensitive screen 4. In some examples, computing device 2 may determine the input unit is not positioned at or near presence-sensitive screen 4 when the input unit is not detectable by the presence sensitive screen 4. For example, a long-press gesture may include a user initially positioning his/her finger at or near a location of presence-sensitive screen 4 for an interval of time. An interval of time may, in one example, be approximately 1 second or longer. At a later time, the user may subsequently remove his/her finger, such that it is not at or near the location of presence-sensitive screen 4 after the interval of time has expired. In some examples, the finger may be detectable by presence-sensitive screen 4 only when at or near the location of presence-sensitive screen 4. In some examples, an input unit may include a finger, input stylus, or pen.

Various aspects of the disclosure may provide, in certain instances, one or more benefits and advantages. For example, a user may enter input values as audio signals more quickly than typing one or more input values. In some instances, a person may speak more quickly than he/she types and therefore entering input values may be quicker when speaking the input values than when typing. The process of entering an input value may be simplified using techniques of the disclosure by enabling a user to provide a gesture at the desired location of the input value and speaking the input value. Integrating the process of entering input data at a desired location using speech recognition may increase user efficiency and provide intuitive, user-friendly techniques to enter data.

Another potential advantage of the present disclosure may include increasing the available area or “screen real estate” of presence-sensitive screen 4 to display content. Techniques of the present disclosure may advantageously increase the available area by eliminating the need for a button, switch or other visible toggling element to, e.g., activate the speech recognition feature computing device 2. For example, because an input field itself may be selected to activate, e.g., the speech recognition feature, no separate toggling element must be displayed on the screen. This may be advantageous because screen real estate on mobile devices may be limited and therefore efficient use of the available area in presence-sensitive screen 4 may be an important design consideration. Consequently, by not displaying a button, switch or other toggling element, more area may be available in GUI 14 to display content other than such a toggling element.

Techniques of the present disclosure may also advantageously reduce the number of gestures required to provide an input value. In some examples, only a single gesture may be used to enter an input value. In this way, a user may not be required to provide multiple gestures to select and enable, e.g., the speech recognition aspects of the present disclosure. Minimizing the number of gestures required to enter input values may increase a user's productivity and enjoyment of a computing device.

FIG. 2 is a block diagram illustrating further details of one example of computing device 2 shown in FIG. 1, in accordance with one or more aspects of the present disclosure. FIG. 2 illustrates only one particular example of computing device 2, and many other example embodiments of computing device 2 may be used in other instances.

As shown in the specific example of FIG. 2, computing device 2 includes one or more processors 40, memory 42, a network interface 44, one or more storage devices 46, input device 48, output device 50, and battery 52. Computing device 2 also includes an operating system 54. Computing device 2, in one example, further includes application 8 and one or more other applications 56. Application 8 and one or more other applications 56 are also executable by computing device 2. Each of components 40, 42, 44, 46, 48, 50, 52, 54, 56, and 6 may be interconnected (physically, communicatively, and/or operatively) for inter-component communications.

Processors 40, in one example, are configured to implement functionality and/or process instructions for execution within computing device 2. For example, processors 40 may be capable of processing instructions stored in memory 42 or instructions stored on storage devices 46.

Memory 42, in one example, is configured to store information within computing device 2 during operation. Memory 42, in some examples, is described as a computer-readable storage medium. In some examples, memory 42 is a temporary memory, meaning that a primary purpose of memory 42 is not long-term storage. Memory 42, in some examples, is described as a volatile memory, meaning that memory 42 does not maintain stored contents when the computer is turned off. Examples of volatile memories include random access memories (RAM), dynamic random access memories (DRAM), static random access memories (SRAM), and other forms of volatile memories known in the art. In some examples, memory 42 is used to store program instructions for execution by processors 40. Memory 42, in one example, is used by software or applications running on computing device 2 (e.g., application 8 and/or one or more other applications 56) to temporarily store information during program execution.

Storage devices 46, in some examples, also include one or more computer-readable storage media. Storage devices 46 may be configured to store larger amounts of information than memory 42. Storage devices 46 may further be configured for long-term storage of information. In some examples, storage devices 46 include non-volatile storage elements. Examples of such non-volatile storage elements include magnetic hard discs, optical discs, floppy discs, flash memories, or forms of electrically programmable memories (EPROM) or electrically erasable and programmable (EEPROM) memories.

Computing device 2, in some examples, also includes a network interface 44. Computing device 2, in one example, utilizes network interface 44 to communicate with external devices via one or more networks, such as one or more wireless networks. Network interface 44 may be a network interface card, such as an Ethernet card, an optical transceiver, a radio frequency transceiver, or any other type of device that can send and receive information. Other examples of such network interfaces may include Bluetooth®, 3G and WiFi® radios in mobile computing devices as well as USB. In some examples, computing device 2 utilizes network interface 44 to wirelessly communicate with an external device (not shown) such as a server, mobile phone, or other networked computing device.

Computing device 2, in one example, also includes one or more input devices 48. Input device 48, in some examples, is configured to receive input from a user through tactile, audio, or video feedback. Examples of input device 48 include a presence-sensitive screen (e.g., presence-sensitive screen 4 shown in FIG. 1), a mouse, a keyboard, a voice responsive system, video camera, microphone (e.g., microphone 6 as shown in FIG. 1) or any other type of device for detecting a command from a user. In some examples, a presence-sensitive screen includes a touch-sensitive screen.

One or more output devices 50 may also be included in computing device 2. Output device 50, in some examples, is configured to provide output to a user using tactile, audio, or video stimuli. Output device 50, in one example, includes a presence-sensitive screen (e.g., presence-sensitive screen 4 shown in FIG. 1), sound card, a video graphics adapter card, or any other type of device for converting a signal into an appropriate form understandable to humans or machines. Additional examples of output device 50 include a speaker, a cathode ray tube (CRT) monitor, a liquid crystal display (LCD), or any other type of device that can generate intelligible output to a user.

In some examples, output device 50 may include one or more projection devices. A projection device may include, for example, a pico projector. In some examples, a projection device may project images and/or video at a display surface. In one example, the images and/or video may be holographic. In some examples, a projection device is integrated into computing device 2 as a combination of hardware and software. In other examples, a projection device is connected to computing device 2 via a wired or wireless connection using technologies such as Universal Serial Bus (USB), IEEE 1394, Bluetooth®, or other well-known connection technologies. Examples of projection devices are illustrated in, e.g., Freeman et al., 2009, Scanned Laser Pico projectors: Seeing the Big Picture (with a Small Device), http://www.microvision.com/pdfs/Scanned%20Laser%20Pico%20Projectors.pdf (Feb. 7, 2011); Darmon et al., 2008, LED-Illuminated Pico Projector Architectures, http://www.sid.org/conf/sid2009/templates/sample.pdf (Feb. 7, 2011).

In some examples, digital images or video displayed on a display surface may include the contents of presence-sensitive screen (e.g., presence-sensitive screen 4 of FIG. 1). Thus, in one example where output device 50 is a pico projector, a user may project GUI 14 of FIG. 1 onto a display surface. A visual projector of computing device 2 may display on a display surface, all or part of the contents displayed in presence-sensitive screen 4 including, for example, one or more input fields and/or one or more input values assigned to one or more input fields.

Computing device 2, in some examples, include one or more batteries 52, which may be rechargeable and provide power to computing device 2. Battery 52, in some examples, is made from nickel-cadmium, lithium-ion, or other suitable material.

Computing device 2 may include operating system 54. Operating system 54, in some examples, controls the operation of components of computing device 2. For example, operating system 54, in one example, facilitates the interaction of application 8 with processors 40, memory 42, network interface 44, storage device 46, input device 48, output device 50, and battery 52. As shown in FIG. 2, application 8 may include input field module 10 and audio conversion module 12 as described in FIG. 1. Input field module 10 and audio conversion module 12 may each include program instructions and/or data that are executable by computing device 2. For example, input module 10 may includes instructions that cause application 8 executing on computing device 2 to perform one or more of the operations and actions described in FIGS. 1-7. Similarity, audio conversion module 12 may include instructions that cause application 8 executing on computing device 2 to perform one or more of the operations and actions described in FIGS. 1-7.

In some examples, input field module 10 and/or audio conversion module 12 may be a part of an operating system executing on computing device 2. In some examples, input field module 10 may communicate with, e.g., a gesture input module, that receives input from one or more input devices of computing device 2. The gesture input module may for example recognize gesture input and provide gesture data to, e.g., application 8. In one example, the gesture input module may be a part of an operating system executing on computing device 2. In one example, input field module 10 may communicate with the gesture input module.

Any applications, e.g., application 8 or other applications 56, implemented within or executed by computing device 2 may be implemented or contained within, operable by, executed by, and/or be operatively/communicatively coupled to components of computing device 2, e.g., processors 40, memory 42, network interface 44, and/or storage devices 46.

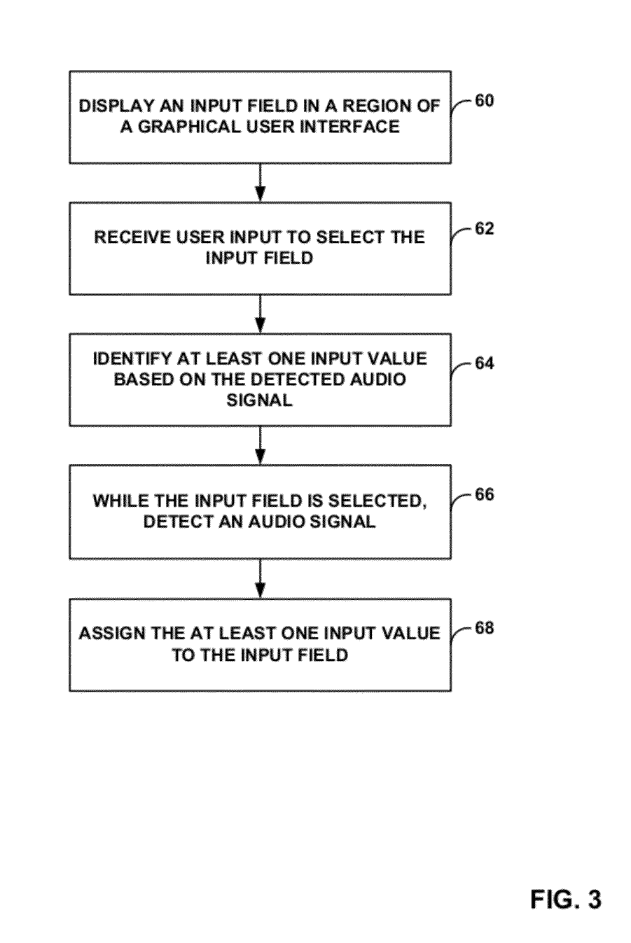

FIG. 3 is a flow diagram illustrating an example method that may be performed by a computing device to enable a user to efficiently input data into one or more input fields of an application. For example, the method illustrated in FIG. 3 may be performed by computing device 2 shown in FIGS. 1 and/or 2.

The method of FIG. 3 includes, displaying, at a presence-sensitive screen of a computing device, an input field in a region of a graphical user interface (60); receiving, at the presence-sensitive screen of the computing device, user input including one or more gestures to select the input field, wherein the one or more gestures to select the input field include motion at a location of the presence-sensitive screen that corresponds to the region of the graphical user interface displaying the input field (62); while the input field is selected, detecting, by the computing device, an audio signal (64); identifying, by the computing device, at least one input value based on the detected audio signal (66); and upon determining that the input field is no longer selected, assigning, by the computing device, the at least one input value to the input field in the graphical user interface (68).

In one example, the method includes, transforming, by the computing device, the audio signal into digital audio data that includes a digital representation of the audio signal; dividing, by the computing device, the digital audio data into one or more digital audio data segments; selecting, by the computing device, a subset of the one or more digital audio segments; providing, by the computing device, a grammar including a plurality of symbols associated with a plurality of pre-defined digital audio data segments, wherein the grammar enables the computing device to identify a symbol based on an audio data segment; and selecting, by the computing device, one or more symbols of the grammar based on a match of the one or more selected digital audio data segments with the plurality of pre-defined digital audio data segments.

In some examples, the match indicates a degree of similarity, within a similarity interval, between the selected digital audio data segments and the plurality of pre-defined digital audio data segments. In some examples, the degree of similarity includes a ratio of equivalence between the selected digital audio data segments and one or more pre-defined digital audio segments of the plurality of digital audio data segments. In some examples, the selected one or more symbols include one or more characters of an alphabet. In some examples, the selected one or more symbols include one or more phonemes, words, or phrases of a language.

In some examples, the one or more symbols include one or more images, videos, or visual objects. In some examples, the one or more gestures include positioning at least one input unit at or near the location of the presence-sensitive screen for an interval of time and subsequently removing the at least one input unit from the location, wherein the input unit is detectable by the presence-sensitive screen only when at or near the location of the presence-sensitive screen. In some examples, the method includes determining, by the computing device, an input field operation based on the input value, wherein the input field operation changes a visual appearance of the input field. In some examples, the method includes, determining, by the computing device, an input field operation based on the input value, wherein the input field operation changes a visual appearance of a first input value assigned to the input field. In some examples, the method includes determining, by the computing device, that the one or more gestures are no longer positioned at or near the presence-sensitive screen.

In some examples, the presence-sensitive screen includes a touch-sensitive screen. In some examples, wherein displaying the input field includes displaying, at the presence-sensitive screen, the input field in a first region of the graphical user interface, wherein the one or more gestures to select the input field include motion from a first location of the presence-sensitive screen that corresponds to the first region of the graphical user interface displaying the input field to a second location that corresponds to a second, different region of the input field in the graphical user interface, and wherein assigning the at least one input value includes assigning, by the computing device, the at least one input value to the second region of the input field in the graphical user interface.

In some examples, the method includes displaying, by the presence-sensitive screen of the computing device, the at least one input value in the region that includes the input field. In some examples, the method includes assigning the at least one input value to the input field in the graphical user interface upon determining that the input field is no longer selected. In some examples, the method includes assigning the at least one input value to the input field in the graphical user interface while the input field is selected. In some examples, the method includes displaying, by a projection device of the computing device, a graphical representation of the input field at a display surface. In some examples, the projection device includes a pico projector. In some examples the method includes, determining, by the computing device, that the input field is no longer selected. In some examples, the input field includes a text box control or a free form drawing control. In some examples, assigning, by the computing device, the at least one input value to the input field in the graphical user interface further includes assigning the at least one input value to any location of the input field.

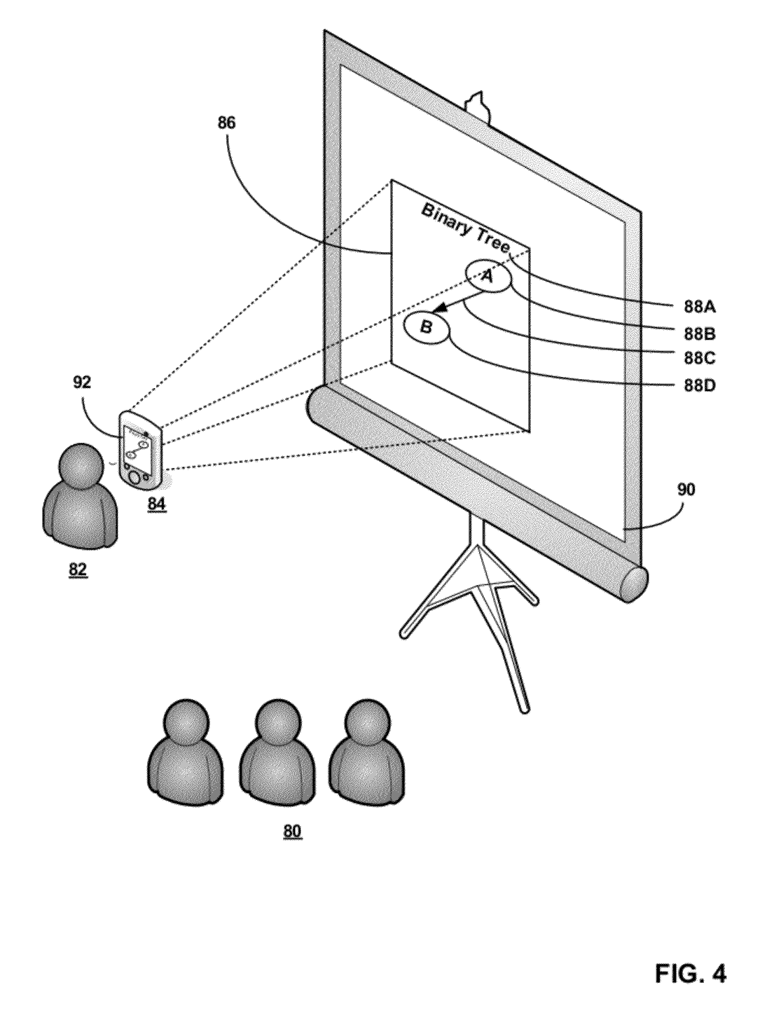

FIG. 4 is a block diagram illustrating an example of a computing device that displays an input field using a pico projector, in accordance with one or more aspects of the present disclosure. As shown in FIG. 4, user 82 operates a computing device 84 similar to computing device 2 as described in FIGS. 1 and 2. Computing device 84 may be, e.g., a smartphone that includes a pico projector as described in FIG. 2. As shown in FIG. 4, the pico projector of computing device 84 may display a graphical representation 86 at a display surface 90. Such techniques may be used, for example, to facilitate collaboration among a group of participants 80. In the example of FIG. 4, user 82 may wish to discuss a binary tree data structure with one or more participants 80

As shown in FIG. 4, user 82 may initially execute a whiteboard application on computing device 84. The whiteboard application executing on computing device 84 may include a single input field 92. Input field 92 may be displayed by the presence-sensitive screen of computing device 84 and may include similar properties and characteristics of input fields described in FIGS. 1 and 2 unless otherwise described hereinafter. The whiteboard application may operate as an electronic whiteboard wherein the user may create, modify, and delete visual content on an electronic canvas displayed by the presence-sensitive screen of computing device 84. The electronic canvas, in some examples, may be implemented as a free-form drawing control.

In some examples, the pico projector of computing device 84 may display a graphical representation of input field 92 on display surface 90. In the current example, user 82 may initially view input field 92 of the whiteboard application on the presence-sensitive screen of computing device 84. User 82 may wish to discuss the visual contents of the whiteboard application with participants 80. To display the visual contents of the whiteboard application including input field 92 to participants 80, user 82 may initially activate the pico projector of computing device 84. Upon activation, the pico projector of computing device 84 may display graphical representation 86. Graphical representation 86 may be any light projection that includes a visual representation of data. In one example, graphical representation 86 may be a visual representation of contents displayed by the presence-sensitive screen of computing device 84 including input field 92. Thus, in some examples, graphical representation 86 may be a replication of some or all visual contents displayed by the presence-sensitive screen of computing device 84.

In the current example of the whiteboard application, the pico projector of computing device 84 displays graphical representation 86 on display surface 90. In some examples, display surface 90 may be a wall or projection screen. In other examples, pico projector 90 may display a mid-air hologram in which case the display surface may be an empty space. In any case, graphical representation 86 may include a representation of visual contents of the whiteboard application executing on computing device 84. Some examples of visual contents include input field 92, which further includes visual objects such as text 88A and visual objects 88B-88D.

As shown in the current example of FIG. 4, user 82 may interact with input field 92 on computing device 84 using various gestures described in, e.g., FIGS. 1 and 2. In some examples, the pico projector of computing device 84 may display changes to input field 92 in real time. For example, user 82 may provide one or more user input values to computing device 84 using techniques described herein, e.g., in FIGS. 1 and 2. The one or more input values received from user 82 may then be reflected in graphical representation 86 in real time. For example, user 82 may perform a long-press gesture near the top of input field 92 at the presence-sensitive screen of computing device 84. While performing the long-press, user 82 may speak “Binary Tree” and subsequently terminate the long-press gesture. Upon terminating the long-press gesture, computing device 84, using the techniques described herein, may assign text 88A to input field 92. The pico projector of computing device 84 may further include text 88A in graphical representation 86. Consequently, participants 80 may see the addition of text 88A to graphical representation 86. Similar techniques may be used to modify and display objects 88B-88D. In this way, user 82 may efficiently collaborate with participants 80 using techniques of the present disclosure.

FIGS. 5-7 are block diagrams illustrating example techniques that enable a user to efficiently input data into one or more input fields of an application, in accordance with one or more aspects of the present disclosure. Techniques of FIGS. 5-7 may, in some examples, be implemented in computing device 2 as shown in FIGS. 1-2 or computing device 84 as shown in FIG. 4. In some examples, FIGS. 5-7 incorporate techniques described in FIGS. 1-4.

FIG. 5, for example, illustrates an input field 100 of an application executing on a computing device. In one example, input field 100 may be displayed by a presence-sensitive screen as shown in FIGS. 1-2. Input field 100 may include one or more visual objects 102A-D. Visual objects may include text, images, video or other content of a graphical user interface. In some examples, an input value may be a visual object. As shown in FIG. 5, user 104 may deliver a presentation on the topic of binary trees.

In the example of FIG. 5, user 104 may wish to add an arrow 102D from visual object 102A to 102B. In one example, user 104 may perform a gesture at or near visual object 102B to add arrow 102D using techniques of the present disclosure. For example, user 104 may initially touch and hold his/her finger at a location of the presence-sensitive screen that displays visual object 102B to select input field 100. After touching and holding a finger at the location of visual object 102B, user 104 may speak the phrase “Arrow from A” 106.

An audio conversion module of the computing device, e.g., as shown in FIGS. 1-2, may receive an audio signal of phrase 106 and determine that phrase 106 is associated with a symbol corresponding to arrow 102D. The audio conversion module and/or input field module may further determine that phrase 106 requires arrow 102D be included from visual object 102A to visual object 102B. In one example, the input field module may cause the presence-sensitive screen to display arrow 102D from visual object 102A to visual object 102B in input field 100. In this way, one or more symbols including one or more images, videos, or visual objects may be added to input field 100 using the techniques of FIGS. 1-3.

FIG. 6 illustrates an example of changing a property of a first input value assigned to the input field, wherein the property of the first input value includes a visual appearance of the first input value. FIG. 6 includes similar characteristics of FIG. 5 unless otherwise described hereinafter. In FIG. 6, user 104 may wish to apply formatting to text 102C. For example, user 104 may wish for text 102C to be bolded and underlined. User 104 may initially touch and hold his/her finger at a location of the presence-sensitive screen that displays text 102C in order to select input field 100.

After touching and holding a finger at the location of text 102C, user 104 may speak the phrase “Bold Underline” 120. An audio conversion module of the computing device, e.g., as shown in FIGS. 1-2, may receive an audio signal of phrase 120 and determine that phrase 120 corresponds to a symbol. The symbol may further correspond to an input field operation that causes an input field module of the computing device to display text 102C in bold and underline formatting as text 122. In other examples, an input field operation may change a property of the input field, wherein the property of the input field includes a visual appearance of the input field. For example, a user may provide a gesture at the presence-sensitive screen and speak a phrase “invert colors,” which inverts the colors of the input field. In another example, a user may provide a gesture and speak a phrase “black and white” which may display the input field using black and white colors. A property may include any aspect of a visual appearance. Other aspects of visual appearance may include font size, resolution, color, input field size, whether the input field or input value is hidden or visible, etc.

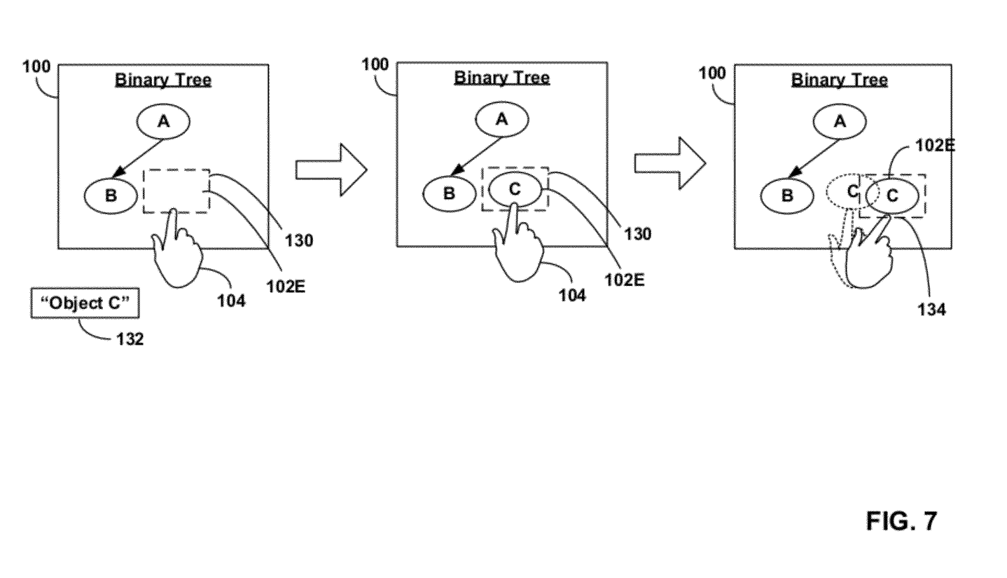

FIG. 7 illustrates an example of assigning an input value from a first region to a second region of an input field. FIG. 7 includes similar characteristics of FIG. 5 unless otherwise described hereinafter. In FIG. 7, user 104 may initially wish to add visual object 102E. In one example, user 104 may perform a long-press gesture by placing his/her finger at or near a region 130 of the presence-sensitive screen to select input field 100. Upon initiating the gesture, user 24 may speak the phrase “Object C” 132. An audio conversion module of the computing device may receive an audio signal of phrase 132 and determine that phrase 132 corresponds to an input field operation that causes visual object 102E to be displayed at region 130. An input field module executing on the computing device may cause the presence-sensitive screen of the computing device to display visual object 102E at or near region 30. In one example, user 104, while his/her finger remains at or near region 130, may move his/her finger to region 134 that is different than region 130. In response to the gesture, the input field module executing on the computing device may cause object 102E to move from region 130 to region 134. In this way, user 104 may move visual objects of an input field to different locations. In another example, user 104 may perform a first gesture to generate visual object 102E and may perform a second, separate gesture to move object 102E to region 134.

As shown in FIG. 7, user 104 may assign an input value to any region or location of input field 100 using techniques of the disclosure. As shown in FIG. 7, user 104 may assign visual object 102E to region 130. User 104 may also assign visual object 102E to a different region 134. In still other examples, user 104 may use techniques of the present disclosure to create and/or assign additional visual objects at other locations or regions of input field 100. In this way, techniques of the present disclosure enable a user to flexibly assign visual objects to any location or region of an input field.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Various aspects of the disclosure have been described. These and other embodiments are within the scope of the following claims.

1. A method comprising:
displaying, at a region of a presence-sensitive screen of a computing device, an input field;
receiving, at the region of the presence-sensitive screen of the computing device, user input comprising one or more gestures to select the input field, wherein the one or more gestures to select the input field comprise motion at the region of the presence-sensitive screen, wherein the one or more gestures comprise positioning at least one input unit at or near the location of the presence-sensitive screen, wherein the input unit is detectable by the presence-sensitive screen only when at or near the location of the presence-sensitive screen;
in response to receiving the user input, determining, by the computing device, that the input field is selected based on the input unit currently being detected by the presence-sensitive screen;
in response to determining that the input field is selected, begin receiving, by the computing device, an audio signal;
in response to determining the input field is no longer selected based on the input unit no longer being detected by the presence-sensitive screen, stop receiving, by the computing device, the audio signal;
identifying, by the computing device, at least one input value based on the received audio signal; and
assigning, by the computing device, the at least one input value to the input field.

2. The method of claim 1, wherein identifying the at least one input value based on the received audio signal further comprises:
defining, by the computing device and based on the received audio signal, digital audio data that comprises a digital representation of the received audio signal;
dividing, by the computing device, the digital audio data into one or more digital audio data segments;
selecting, by the computing device, a subset of the one or more digital audio segments;
providing, by the computing device, a grammar comprising a plurality of symbols associated with a plurality of pre-defined digital audio data segments, wherein the grammar enables the computing device to identify a symbol based on an audio data segment; and
selecting, by the computing device, one or more symbols of the grammar based on a match of the one or more selected digital audio data segments with the plurality of pre-defined digital audio data segments.

3. The method of claim 2, wherein the match indicates a degree of similarity, within a similarity interval, between the selected digital audio data segments and the plurality of pre-defined digital audio data segments.

4. The method of claim 3, wherein the degree of similarity comprises a ratio of equivalence between the selected digital audio data segments and one or more pre-defined digital audio segments of the plurality of digital audio data segments.

5. The method of claim 2, wherein the selected one or more symbols comprise one or more characters of an alphabet.

6. The method of claim 2, wherein the selected one or more symbols comprise one or more phonemes, words, or phrases of a language.

7. The method of claim 2, wherein the one or more symbols comprise one or more images, videos, or visual objects.

8. (canceled)

9. The method of claim 1, wherein assigning, by the computing device, the at least one input value to the input field further comprises:
determining, by the computing device, an input field operation based on the input value, wherein the input field operation changes a visual appearance of the input field.

10. The method of claim 1, wherein assigning, by the computing device, the at least one input value to the input field further comprises:
determining, by the computing device, an input field operation based on the input value, wherein the input field operation changes a visual appearance of the at least one input value assigned to the input field.

11. The method of claim 1, further comprising:
determining, by the computing device, that the input field is no longer selected in response to the one or more gestures no longer being detected, by the presence-sensitive screen, at or near the presence-sensitive screen.

12. The method of claim 1, wherein the presence-sensitive screen comprises a touch-sensitive screen.

13. The method of claim 1,
wherein the input value is initially displayed at a first location of the presence-sensitive screen, and wherein the method further comprises:
receiving, by the computing device, a second user input comprising one or more gestures, wherein the one or more gestures of the second user input comprise motion from the first location of the presence-sensitive screen to a second, different location of the presence-sensitive screen; and
displaying, by the presence-sensitive screen of the computing device, the at least one input value at the second location of the presence-sensitive screen.

14. The method of claim 1, wherein assigning, by the computing device, the at least one input value to the input field further comprises:
displaying, by the presence-sensitive screen of the computing device, the at least one input value at the region of the presence-sensitive screen that displays the input field.

15. The method of claim 1, wherein assigning, by the computing device, the at least one input value to the input field further comprises:
assigning the at least one input value to the input field upon determining that the input field is no longer selected.

16. The method of claim 1, wherein assigning, by the computing device, the at least one input value to the input field further comprises:
assigning the at least one input value to the input field while the input field is selected.

17. The method of claim 1, further comprising:
displaying, by a projection device of the computing device, a graphical representation of the input field at a display surface.

18. The method of claim 17, wherein the projection device comprises a pico projector.

19. The method of claim 1, further comprising:
determining, by the computing device, that the input field is no longer selected.

20. The method of claim 1, wherein the input field comprises a text box control or a free form drawing control.

21. The method of claim 1, wherein assigning, by the computing device, the at least one input value to the input field further comprises assigning the at least one input value to any location of the input field.

22. A computer-readable storage medium encoded with instructions that, when executed by one or more processors of a computing device, cause the one or more processors to perform operations comprising:
displaying, at a region of a presence-sensitive screen, an input field;
receiving, at the region of the presence-sensitive screen, user input comprising one or more gestures to select the input field, wherein the one or more gestures to select the input field comprise motion at the region of the presence-sensitive screen, wherein the one or more gestures comprise positioning at least one input unit at or near the location of the presence-sensitive screen, wherein the input unit is detectable by the presence-sensitive screen only when at or near the location of the presence-sensitive screen;
in response to receiving the user input, determining the input field is selected based on the input unit currently being detected by the presence-sensitive screen,
in response to determining that the input field is selected, begin receiving, an audio signal;
in response to determining the input field is no longer selected based on the input unit no longer being detected by the presence-sensitive screen, stop receiving the audio signal;
identifying at least one input value based on the received audio signal; and
assigning the at least one input value to the input field.

23. A computing device, comprising:
one or more processors;
an input device;
a presence-sensitive screen that is operable to display an input field at a region the presence-sensitive screen;
wherein the presence-sensitive screen is operable to receive, at the region of the presence-sensitive screen, user input comprising one or more gestures to select the input field, wherein the one or more gestures to select the input field comprise motion at a the region of the presence-sensitive screen, wherein the one or more gestures comprise positioning at least one input unit at or near the location of the presence-sensitive screen, wherein the input unit is detectable by the presence-sensitive screen only when at or near the location of the presence-sensitive screen;
an input field module operable by the one or more processors to, in response to receiving the user input, determining that the input field is selected based on the input unit currently being detected by the presence-sensitive screen;
wherein the input device is operable to begin receiving an audio signal in response to determining the input field is selected;
wherein input device is operable by the one or more processors to, in response to determining the input field is no longer being detected by the presence-sensitive screen, stop receiving the audio signal;
an audio conversion module operable by the one or more processors to identify at least one input value based on the received audio signal; and
wherein the input field module is operable by the one or more processors to assign the at least one input value to the input field.
